(19) United States
(12) Patent Application Publication
(10) Pub. No.: US 2012/0327738 A1
(43) Pub. Date: Dec. 27, 2012

(54) AUTOMATIC SYSTEM FOR MIXING CLEANSING AGENTS WITH A WATER STREAM

(76) Inventor: Andrea Coonrod, Roswell, GA (US)

(21) Appl. No.: 13/529,976

(22) Filed: Jun. 21, 2012

Related U.S. Application Data
(60) Provisional application No. 61/499,982, filed on Jun. 22, 2011.

(51) Int. Cl. B01F 15/02

(52) U.S. Cl. 366/150.1

(57) ABSTRACT

An automatic system for mixing cleansing agents with a water stream. The automatic system for mixing cleansing agents includes a activation device, electrical control unit (ECU), dispenser and mixing chamber. The activation device may be activated when a motion is detected to provide a signal to the ECU. A motor connected to a pump of the dispenser may be actuated by the ECU to dispense a cleansing agent into the mixing chamber. The cleansing agent is sucked into a pipeline by a tube and is mixed with water in the mixing chamber to produce a sudsy water exiting a water distributor.

### BACKGROUND OF THE INVENTION

1. Field of the Invention

The present invention relates to a system for cleansing agents to automatically enter a water stream that allows a user to wash without manually scrubbing cleansing agent on their body. This invention may be used for people with disabilities and may also be used by an elderly person who has trouble reaching while in the shower.

2. Discussion of the Related Art

The use of dispensers for liquid cleansing agents and shampoos is known in the prior art. More specifically, dispensers for liquid cleansing agents heretofore devised and utilized are known to consist basically of familiar, expected and obvious structural configurations, notwithstanding the myriad of designs encompassed by the related art which have been developed for the fulfillment of countless objectives and requirements.

While these devices fulfill their respective, particular objectives and requirements, the aforementioned related art do not disclose an automatic system for mixing cleansing agents with a water stream. The inventive system includes a housing having a top and a bottom, a activation device and a light indicator mounted on the housing, an electrical control unit (ECU) mounted within the housing, where the ECU receives a signal from the activation device, a motor actuated by the ECU, a dispenser including a pump driven by the motor, a mixing chamber; and a water distributor for outputting a saturated mixture of water and cleansing agent.

In these respects, the automatic system for mixing cleansing agents with a water stream according to the present invention substantially departs from the conventional concepts and designs of the related art, and in so doing provides a system primarily developed for the purpose of automatically mixing cleansing agents with a water stream.

### SUMMARY OF THE INVENTION

Accordingly, the present invention is directed to an automatic system for mixing cleansing agents with a water stream. The system may be employed in a number of different applications. For example, the system may be used in showers, sinks, carwash, garden hose or any other type of application where a mixture of water and cleansing fluid may be desired. For purposes of this specification description, the apparatus is described as applied to a shower. This one embodiment, however, should not be viewed as limiting as the same apparatus can easily be employed in the other above mentioned applications.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided An automatic system for mixing cleansing agents with a water stream including a housing having a top and a bottom, a activation device and a light indicator mounted on the housing, an electrical control unit (ECU) mounted within the housing, where the ECU receives a signal from the activation device, a motor actuated by the ECU, a dispenser including a pump driven by the motor, a mixing chamber; and a water distributor for outputting a saturated mixture of water and cleansing agent.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of the automatic system for mixing cleansing agents with a water stream in accordance with the present invention;

FIG. 2 is a schematic view of the cleansing agent dispenser of FIG. 1;

FIG. 3 is perspective view of the mixing chamber of FIG. 1;

FIG. 4 is a block diagram of the automatic system for mixing cleansing agents with a water stream.

FIG. 5 is diagram view of a belt and pulley mechanism in accordance with an exemplary embodiment of a pump system for the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

Hereinafter, an automatic system for mixing cleansing agents with a water stream will be described with reference to the accompanying drawings.

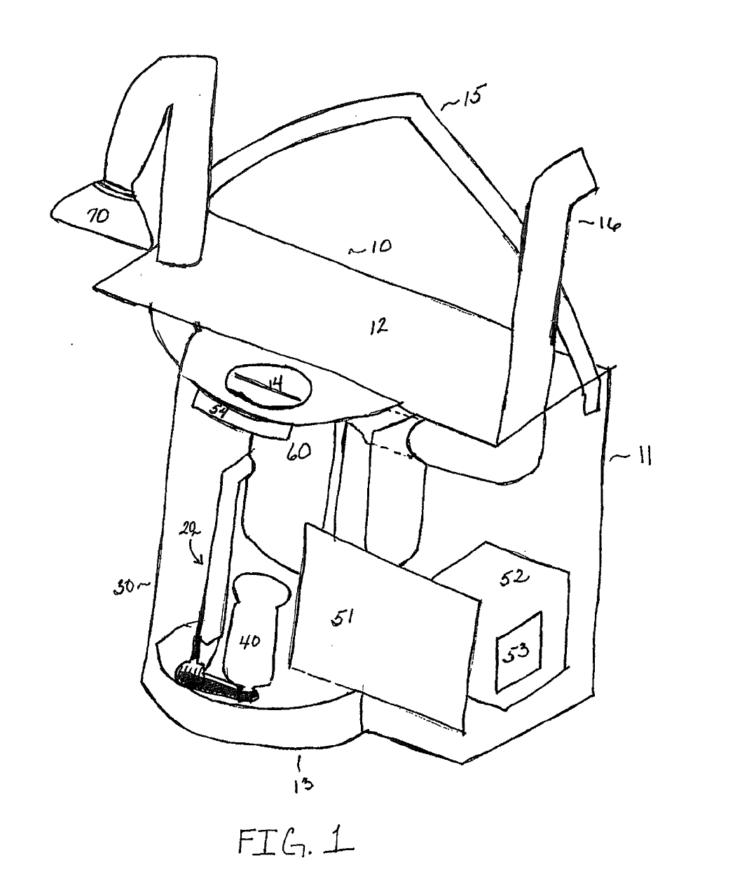

As best illustrated in FIGS. 1 through 4 an automatic system 10 for mixing cleansing agents with a water stream generally comprises a housing 11 having a top 12, a bottom 13 and a lid 14. The housing 11 may be designed for mounting to any water distributor 70, particularly a shower head as illustrated in FIG. 1. The housing 11 may include a water tight body with a handle 15 extending from the top 12 of the housing 11. A activation device 53 may be provided on the housing 11. An ECU 50, a dispenser 30 and a mixing chamber 60 may be provided inside of the housing. The activation device 53 may be activated when it detects a motion. Once activated, the activation device 53 may provide a signal to the ECU 50. The ECU 50 actuates a motor 40 connected to a pump 20 of the dispenser 30 to dispense a cleansing agent to the mixing chamber 60. The cleansing agent may be sucked into a pipeline by a tube 61 and mixed with water in the mixing chamber 60 producing a sudsy water exiting the water distributor 70. The system 10 may be designed for providing a cleansing agent directly into a passing stream of water without having the liquids mix and dilute each other in the mixing chamber 60.

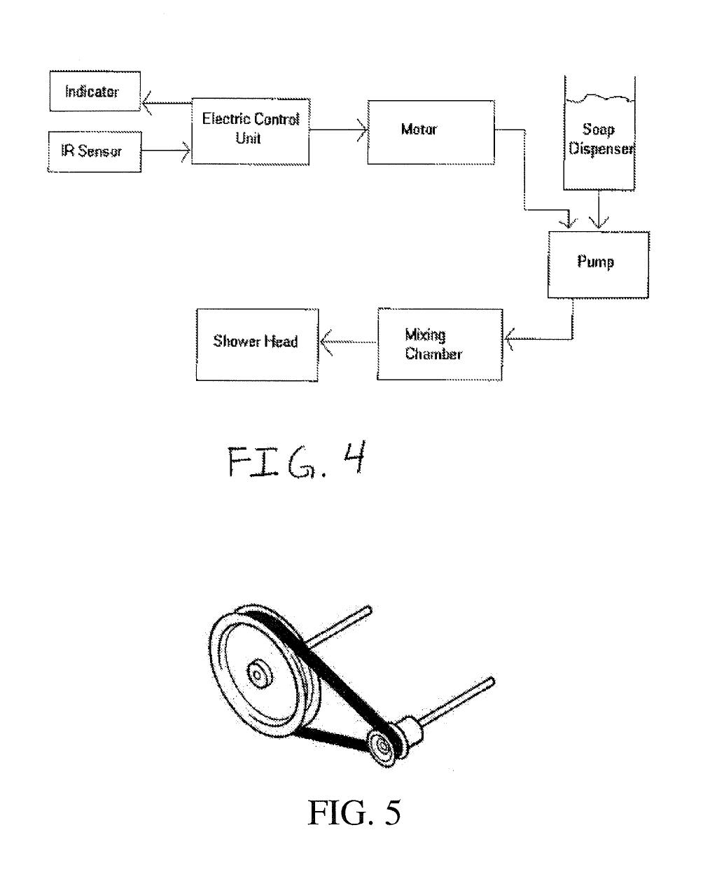

An exemplary operation of the system 10 is illustrated in the block diagram of FIG. 4. The system 10 may be a touch free system and output a timed flow of a mixture of a cleansing agent and water. The cleansing agent may include, for example, soap or shower gel. When the activation device 53 is activated, the system 10 may be turned on and a signal may be given to the ECU 50. The motor 40 connected to the pump 20 of the cleansing agent dispenser 30 may be then actuated by the ECU 50 to pump the cleansing agent. The pump 20 may be driven by the motor 40 for a timed interval, preferably 10 seconds, and cleansing agent may be dispensed to the mixing chamber 60 for that amount of time. The volume of the cleansing agent that is dispensed into the mixing chamber 60 can be, for example, 32 ml per cycle. The cleansing agent in the mixing chamber 60 may be then sucked into the pipeline 62 by a tube 61 and mixed with water due to the high velocity of the water coming through the nozzle 63. Accordingly, water output by the water distributor 70 will be sudsy water.

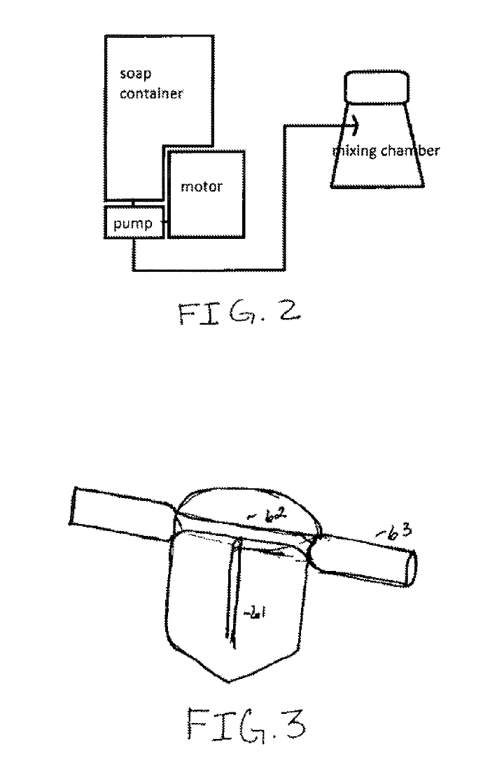

Activation device 53 may include, for example, an infrared sensor that detects motion such as hand waving by a user. In such an embodiment, a user can activate the system 10, for example, by providing a motion that can be detected by activation device 53, for example by providing motion in front of or on top of activation device 53. Alternatively, activation device 53 may include a mechanical or electrical switch that is manually operated such a push button, switch, or lever. In an exemplary embodiment the activation device 53 may also be operated by remote control. A light indicator 54 may be illuminated to let the user know that the system 10 is running. Once the activation device is enabled a signal is given to the ECU 50, which may be designed to control motor 40. The motor 40 may be engaged to pump the cleansing agent into the mixing chamber. Once there, the cleansing agent may be sucked into a pipeline 62 where it can be mixed with water due to the high velocity of the water coming through the nozzle 63, see FIG. 2.

The ECU may include a circuit board 51, power source 52 and may be connected to activation device 53. Circuit board 51 may be programmed to run the timing system for the pump 20. In an exemplary embodiment the circuit board may be an Arduino UNO USB Board can be powered via a USB connection or with an external power supply. The power source may be selected automatically. As discussed previously, external (non-USB) power can come either from an AC-to-DC adapter (wall-wart) or battery. The adapter can be connected by plugging a 2.1 mm center-positive plug into the board's power jack. Leads from a battery can be inserted in the Gnd and Vin pin headers of the POWER connector. The board can operate on an external supply of 6 to 20 volts. If supplied with less than 7V, however, the 5V pin may supply less than five volts and the board may be unstable. The Arduino UNO USB Board is only an exemplary embodiment and should not be viewed as limiting. Other types of circuit boards, even less advanced types, that are capable of operating the pump and receive a signal from activation device 53 may also be employed.

A belt and pulley mechanism may be used for the pump 20 to generate pressure force on the cleansing agents. An exemplary embodiment of a belt and pulley mechanism that may be used for the pump is illustrated in FIG. 5. The belts are used as a source of motion and to transmit power from a small gear on the motor shaft to a large pulley sitting under the cleansing agent container. In operation, motor 40 would turn the motor shaft and thus the small gear. The small gear would in turn operate the belt that also engages the larger pulley located under the cleansing agent container. In this manner the larger pulley can be operated to pump the cleansing agent from the container to the mixing chamber where it can then be mixed with water. This is accomplished by having the mixing chamber connected to the cleansing agent container. Any structure suitable for the flow or transfer of the cleansing agent can be used to make the connection.

In one embodiment, the connection may be made with a tube that runs into the cleansing agent in the cleansing agent container. In this embodiment, when the pump system 20 is turned on, the motor drives the pump that in turn pushes the air and cleansing agent out of the tube. When the pump system 20 is turned off, the cleansing agent may be drawn up in the tube, and out of the pump spigot.

In the system 10, the motor shaft drives the pump 20 and it receives power from the power source 52. The power source 52 may include four AA batteries connected in series. Other types of battery packs may also be employed. Alternative sources of electrical power may also be employed such as external power, i.e. direct current from an outlet or directly wired to the wall or mounting apparatus. Power may also be supplied through a separate power generator. The power provided by the power source 52 must be sufficiently high for the pump 20 to eject the cleansing agent out of the tube that runs into the cleansing agent in the cleansing agent container. The amount of power required by the motor depends on the pressure loss along the tube that runs into the cleansing agent in the cleansing agent container. The ECU 50 of the system may be programmed such that the motor will run for a predetermined duration of time, for example about 10 seconds. The time may be an estimate of ideal amount of liquid cleansing agents to be ejected out per every normal shower per person.

The mixing system allows for the cleansing agents to be properly mixed with water before exiting the water distributor 70 as saturated water cleansing agent mixture. The cleansing agent may be pulled directly into a passing stream of water without having the liquids mix and dilute each other in the mixing container 60. In an exemplary embodiment, pump 20 and/or an additional pump that may have a similar design to pump 20 located in the mixing chamber may be used to inject the soap directly into the stream of water. Alternatively, the system 10 may be able to pull up liquid cleansing agents without pumps or moving parts which is a huge advantage for ease of manufacturing and system maintenance. This system 10 also has the advantage of having a uniform mixture with a gradual dispensing rate.

In an exemplary embodiment, the mixing chamber 60 narrows hose 63 for the passage of water coming down from water supply line 16. In so doing, the system employs a venturi effect of a converging-diverging nozzle 63, as illustrated in FIG. 3 to convert the pressure energy of a motive fluid to velocity energy which creates a low pressure zone that draws in and entrains a suction fluid. After passing through the throat of the nozzle, the mixed cleansing agent and water expands and the velocity is reduced which results in recompressing the mixed fluids by converting velocity energy back into pressure energy.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An automatic system for mixing cleansing agents with a water stream comprising:
a housing having a top, a bottom;
a activation device and a light indicator mounted on the housing;
an electrical control unit (ECU) mounted within the housing, wherein the ECU receives a signal from the activation device;
a motor actuated by the ECU;
a dispenser including a pump driven by the motor;
a mixing chamber; and
a water distributor for outputting a saturated mixture of water and cleansing agent.
